(19) United States
(12) Patent Application Publication
(10) Pub. No.: US 2014/0376097 A1
(43) Pub. Date: Dec. 25, 2014

(54) MICROLENS ARRAY AND IMAGING ELEMENT PACKAGE

(71) Applicant: ASAHI GLASS COMPANY, LIMITED, Chiyoda-ku (JP)

(72) Inventors: Shuichi YAMASHITA, Tokyo (JP); Atsushi MATSUO, Tokyo (JP); Mitsuo OSAWA, Tokyo (JP)

(73) Assignee: ASAHI GLASS COMPANY, LIMITED, Chiyoda-ku (JP)

(21) Appl. No.: 14/479,833

(22) Filed: Sep. 8, 2014

Related U.S. Application Data
(63) Continuation of application No. PCT/JP2013/055877, filed on Mar. 4, 2013.

(30) Foreign Application Priority Data
Mar. 7, 2012 (JP) 2012-050641

(51) Int. Cl. G02B 3/00

(52) U.S. Cl. CPC G02B 3/0037
USPC 359/619

(57) ABSTRACT

A microlens array to be used in combination with a pixel array of an imaging element. The microlens includes a glass substrate; and a plurality of microlenses provided on at least one surface of the glass substrate and arranged in an array shape. Each of the plurality of the microlenses is constituted such that light to be entered into the microlens is received by a plurality of pixels of the imaging element. A difference between a coefficient of linear expansion of the glass substrate and a coefficient of linear expansion of an imaging element substrate having the pixel array formed thereon or member of a package to be bonded to the imaging element substrate is within 8×10⁻⁶ (/K).

### TECHNICAL FIELD

The present invention relates to a microlens array and an imaging element package in which the microlens array and an imaging element substrate are integrated.

### BACKGROUND ART

There is an imaging device in which a microlens array is placed above an incidence plane side of an imaging element substrate having light receiving elements provided thereon corresponding to given pixel pitches, light is entered in the light receiving elements through the microlens array, and a desired light receiving signal is obtained. In the case of such an imaging device using the microlens array in combination with a light receiving element array on the imaging element substrate (hereinafter referred to as pixel array of an imaging element), when position shift occurs between each microlens array and each light receiving element, a problem that correct picture image and image information are not obtained occurs. For this reason, to prevent such position shift, it is performed to directly bond an imaging element substrate having a pixel array formed thereon or its package to a microlens array substrate having a microlens array formed thereon through an adhesive.

However, when a difference in coefficient of thermal expansion between the microlens array substrate and an imaging element substrate or package bonded to the imaging element substrate, to which the microlens array substrate is bonded, is large, there was a problem that position shift of a pixel pitch of an imaging element and lens pitch due to a working temperature or heat generation occurs.

As a technique for preventing position shift due to a difference in coefficient of thermal expansion between substrates or between a substrate and a package, that are used in combination, for example, Patent Document 1 describes that in an image exposure device using a spatial light modulator such as DMD in combination with a microlens array, an intermediate member of a material having a coefficient of linear expansion which is average between that of the microlens array and that of a holding member of a device using the microlens array is interposed between the microlens array and the holding member.

Patent Document 2 describes that to respond to size reduction and high quality of a camera mounting an imaging device, a material having the same degree of a coefficient of thermal expansion as a coefficient of thermal expansion of a package is used in a material of a window material so as not to cause breakage or strain when using the window material which was bonded to the package in a structure of giving an aberration correction function to a window material for a solid-state image sensing element package.

### PRIOR ART DOCUMENTS

### Patent Document

Patent Document 1: JP-A-2006-258852

Patent Document 2: JP-A-2011-49275

### SUMMARY OF THE INVENTION

### Problems That the Invention Is to Solve

In recent years, an imaging device called a light field camera is being developed. The light field camera is a device in which light received by one microlens is received by a plurality of pixels, and additionally, each microlens is partially overlapped with a pixel region on which light is received, a microlens array designed so as to cover the entire pixels of the imaging element with the entire microlens array is provided on an upper surface of an imaging element substrate, and light is entered in a pixel array of the imaging element through the microlens array, and depth information can be thereby dispersed and recorded in a plurality of pixels. By dispersing and recording the depth information in the plurality of the pixels, for example, focus image is reconstructed on the basis of the information, and a variety of images such as each focused image and three-dimensional range image can be obtained.

In the case of an imaging device using a microlens array for recording depth information of an object in a plurality of pixels, such as the light field camera, a problem by position shift described above becomes particularly remarkable.

However, in the method described in Patent Document 1, in the case of interposing an intermediate member between the microlens array and a holding member of a device using the microlens array, it is difficult to sufficiently obtain positional accuracy of an microlens array and a pixel, required in a light field camera. Furthermore, if it is tried to sufficiently obtain the positional accuracy, an attaching structure becomes complicated, and there is a problem that alignment between the microlens array and the pixel array becomes difficult.

The method described in Patent Document 2 describes that in the structure giving an aberration correction function to a window material of a package, a coefficient of thermal expansion of a material of the window material is made to have the same degree of a coefficient of thermal expansion of the package, but does not disclose a combination with a microlens array substrate. For this reason, for example, to sufficiently obtain the positional accuracy, it is unclear as to whether the microlens array substrate can be constituted of the material of the window material of a package, and to what extent a coefficient of thermal expansion should be adjusted. Thus, the method cannot be directly applied.

In the case of using a production process by chip size package that is recently investigated by the demand in size reduction of an imaging device, an imaging element substrate is directly bonded to a cover glass through a spacer. Therefore, a package itself is not present, and the method described in Patent Document 2 cannot be applied.

Accordingly, the present invention has an object to provide an microlens array that can prevent position shift of a pixel pitch of an imaging element and lens pitch in an imaging device using a microlens array in combination with a pixel array of an imaging element, and an imaging element package including the microlens array and an imaging element substrate that are integrated.

Furthermore, the present invention has an object to provide an imaging element package including a microlens array that can prevent noise generation in a light receiving element due to α-ray emitted from a substrate having the microlens array formed thereon, in addition to the prevention of position shift between the microlens array and a light receiving element array, and an imaging element package in which the microlens array and an imaging element substrate are integrated.

### Means for Solving the Problems

The microlens array in the present invention relates to a microlens array to be used in combination with a pixel array of an imaging element, comprising: a glass substrate; and a plurality of microlenses provided on at least one surface of the glass substrate and arranged in an array shape, wherein each of the plurality of the microlenses is constituted such that light to be entered into the microlens is received by a plurality of pixels of the imaging element, and a difference between a coefficient of linear expansion of the glass substrate and a coefficient of linear expansion of an imaging element substrate having the pixel array formed thereon or member of a package to be bonded to the imaging element substrate is within 8×10⁻⁶ (/K).

The term “a difference between a coefficient of linear expansion of a glass substrate and a coefficient of linear expansion of an imaging element substrate having a pixel array formed thereon or member of a package to be bonded to the imaging element substrate is within 8×10⁻⁶ (/K)” used herein means that an absolute value of the difference between a coefficient of linear expansion of a glass substrate and a coefficient of linear expansion of an imaging element substrate having a pixel array formed thereon or member of a package to be bonded to the imaging element substrate is 8×10⁻⁶ (/K) or less. Furthermore, the coefficient of linear expansion means a proportion of the change of a length depending on temperature increase. When a coefficient of linear expansion is a, a length of an object is L and a temperature is T, the relationship of those is α=1/L·(dL/dT).

In the microlens array in the present invention, an amount of an α-ray emission from the glass substrate may be 0.01 c/cm²·hr or less.

The microlens array in the present invention may further comprise a resin layer stacked on the glass substrate, wherein the plurality of the microlenses may be formed in the resin layer.

The microlens array in the present invention may further comprise a cover layer covering a region on which at least the microlens is formed.

In the microlens array in the present invention which is to be bonded to a silicon substrate as the imaging element substrate, a coefficient of linear expansion of the glass substrate may be within a range of from 0.3×10⁻⁶ (/K) to 11×10⁻⁶ (/K).

In the microlens array in the present invention which is to be bonded to a germanium substrate as the imaging element substrate, a coefficient of linear expansion of the glass substrate may be within a range of from 0.3×10⁻⁶ (/K) to 14×10⁻⁶ (/K).

In the microlens array in the present invention which is to be bonded to a ceramics package as the package of the imaging element substrate, a coefficient of linear expansion of the glass substrate may be within a range of from 0.3×10⁻⁶ (/K) to 15×10⁻⁶ (/K).

The imaging element package in the present invention comprises: an imaging element substrate on which a light receiving element is formed corresponding to a given pixel pitch; and a microlens array in which a plurality of microlenses are arranged in an array shape on at least one surface of a glass substrate, wherein each of the plurality of the microlenses constituting the microlens array makes the light receiving element corresponding to a plurality of pixels on the imaging element substrate receive light to be entered into the microlens, a difference between a coefficient of linear expansion of the glass substrate of the microlens array and a coefficient of linear expansion of the imaging element substrate or member of a package to be bonded to the imaging element substrate is within 8×10⁻⁶ (/K), and the glass substrate of the microlens array is bonded to the imaging element substrate or package to which the imaging element substrate is bonded, through a resin material.

### Advantageous Effects of the Invention

According to the present invention, in an imaging device using a pixel array of an imaging element in combination with a microlens array constituted such that a plurality of microlenses are arranged in an array shape at given intervals and each microlens makes a plurality of pixels of the imaging element receive light to be entered into the microlens, position shift of a pixel pitch of the imaging element and lens pitch can be prevented.

### BRIEF DESCRIPTION OF THE DRAWINGS

FIG. 1 is a configuration diagram showing an example of a microlens array in the present invention.

FIG. 2 is an explanatory view showing one example of a production method of a microlens array in the present invention.

FIG. 3 is an explanatory view showing another example of a production method of a microlens array in the present invention.

FIG. 4 is a configuration diagram showing another example of a microlens array in the present invention.

FIG. 5 is a configuration diagram showing another example of a microlens array in the present invention.

FIG. 6 is a configuration diagram showing another example of a microlens array in the present invention.

FIG. 7 is a configuration diagram showing another example of a microlens array in the present invention.

FIG. 8 is an explanatory view showing an example of a microlens array bonded to an imaging element substrate or imaging element package.

FIG. 9 is an explanatory view showing an example of a microlens array bonded to an imaging element substrate.

FIG. 10 is an explanatory view showing an example of a microlens array bonded to an imaging element substrate.

FIG. 11 is an explanatory view showing an example of a microlens array bonded to an imaging element substrate.

FIG. 12 is an explanatory view showing an example of a microlens array bonded to an imaging element package.

### MODE FOR CARRYING OUT THE INVENTION

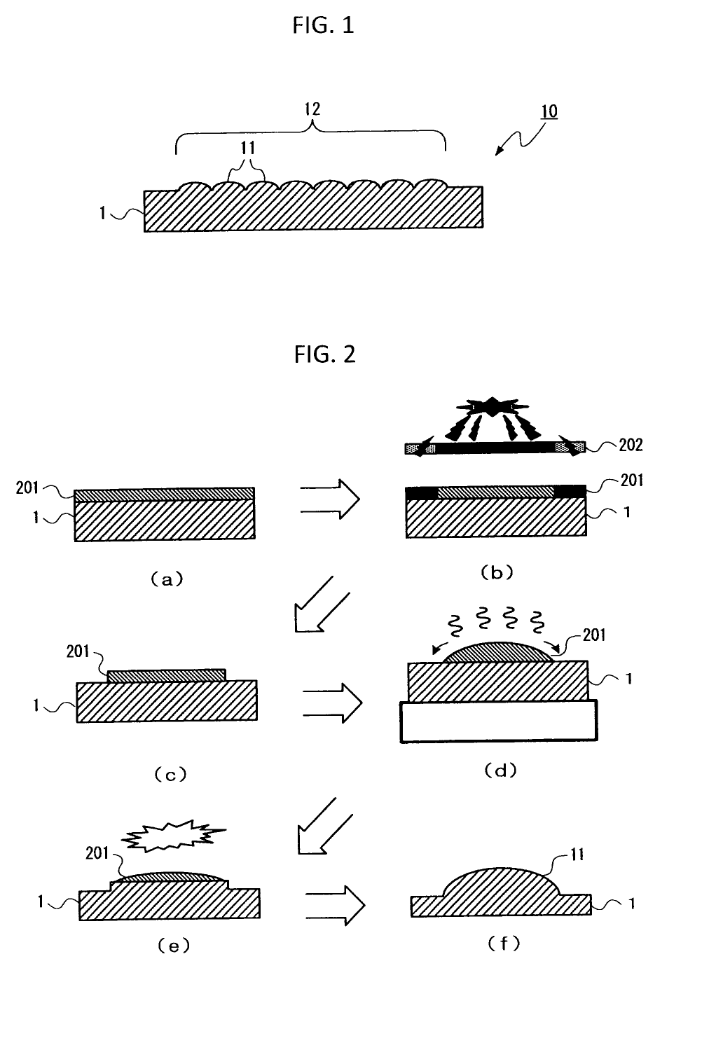

Embodiments of the present invention are described below by reference to the drawings. FIG. 1 is a configuration diagram showing an example of a microlens array in the present invention. A microlens array 10 shown in FIG. 1 is formed by providing a microlens array structure 12 on one light-transmitting surface of a glass substrate 1. In the present invention, the term “microlens array” means an entire structure including a substrate and a microlens array structure 12 provided thereon. In the present invention, a substrate having the microlens array structure 12 provided thereon is defined as a “microlens array substrate”.

The microlens array structure 12 means a structure formed by providing a plurality of microlenses 11 in an array shape. FIG. 1 shows an example of directly forming the microlens array structure 12 on the glass substrate 1 constituting the microlens array substrate.

In the glass substrate 1, a material having the same or close coefficient of linear expansion as that of an imaging element substrate or imaging element package, to which the glass substrate 1 is to be bonded, (hereinafter simply referred to as an “bonded part”) is used.

For example, when a material of the bonded part is silicon, a material having a coefficient of linear expansion of from about 0.3×10⁻⁶ to 11×10⁻⁶/K is preferred as a material of the glass substrate 1, a material having a coefficient of linear expansion of from about 0.3×10⁻⁶ to 6×10⁻⁶/K is more preferred as the material of the glass substrate 1, and a material having a coefficient of linear expansion of from about 2×10⁻⁶ to 4×10⁻⁶/K is still more preferred as the material of the glass substrate 1.

Specific examples of such a material include glasses such as quartz, aluminosilicate glass, borosilicate glass; “AF33”, “AF32”, “BOROFLOAT 33”, “D263T”, “D263Teco”, “D263LA” and “B270”, manufactured by Schott; “SW-3”, “SW-Y”, “SW-YY”, “AN100”, “EN-A1”, “PYREX”, “FP1”, “FP10”, “FP01 eco”, “FL” and “JFL”, manufactured by Asahi Glass Co., Ltd.; “Eagle 2000” and “Eagle XG”, manufactured by Corning Incorporated; and “ABC” and “BDA”, manufactured by Nippon Electric Glass Co., Ltd. (the above products include the cases of trade names and registered trademarks). Particularly, glasses such as quartz: “AF33”, “AF32”, and “BOROFLOAT 33”, manufactured by Schott; “SW-3”, “SW-Y”, “SW-YY”, “AN100”, “EN-A1” and “PYREX”, manufactured by Asahi Glass Co., Ltd.; “Eagle 2000” and “Eagle XG”, manufactured by Corning Incorporated; and “ABC” manufactured by Nippon Electric Glass Co., Ltd. (the above products include the cases of trade names and registered trademarks) have a coefficient of thermal expansion close to that of silicon and are more preferred.

Furthermore, for example, when a material of the bonded part is germanium, a material having a coefficient of linear expansion of from about 0.3×10⁻⁶ to 14×10⁻⁶/K is preferred as a material of the glass substrate 1, a material having a coefficient of linear expansion of from about 3×10⁻⁶ to 9×10⁻⁶/K is more preferred as the material of the glass substrate 1, and a material having a coefficient of linear expansion of from about 5×10⁻⁶ to 7×10⁻⁶/K is still more preferred as the material of the glass substrate 1.

Specific examples of such a material include glasses such as quartz, aluminosilicate glass, borosilicate glass, phosphate glass, fluorophosphate glass; “AF33”, “AF32”, “BOROFLOAT 33”, “D263T”, “D263Teco”, “D263LA” and “B270”, manufactured by Schott; “SW-3”, “SW-Y”, “SW-YY”, “AN100”, “EN-A1”, “PYREX”, “FP1”, “FP10”, “FP01eco”, “FL”, “JFL” and “NF50”, manufactured by Asahi Glass Co., Ltd.; “Eagle 2000” and “Eagle XG”, manufactured by Corning Incorporated; and “ABC” and “BDA”, manufactured by Nippon Electric Glass Co., Ltd. (the above products include the cases of trade names and registered trademarks). Particularly, glasses such as “AF33”, “AF32”, “BOROFLOAT 33”, “D263T”, “D263Teco”, “D263LA” and “B270”, manufactured by Schott; “SW-3”, “SW-Y”, “SW-YY”, “AN 100”, “EN-A1”, “PYREX”, “FP1”, “FP10”, “FP01eco”, “FL” and “JFL”, manufactured by Asahi Glass Co. Ltd.; “Eagle 2000” and “Eagle XG”, manufactured by Corning Incorporated; and “ABC” and “BDA”, manufactured by Nippon Electric Glass Co., Ltd. have a coefficient of thermal expansion close to that of germanium and are more preferred as the material of the glass substrate 1.

Furthermore, for example, when a material of the bonded part is ceramics such as alumina, a material having a coefficient of linear expansion of from about 0.3×10⁻⁶ to 15×10⁻⁶/K is preferred as a material of the glass substrate 1, a material having a coefficient of linear expansion of from about 4×10⁻⁶ to 10×10⁻⁶/K is more preferred as the material of the glass substrate 1, and a material having a coefficient of linear expansion of from about 6×10⁻⁶ to 8×10⁻⁶/K is still more preferred as the material of the glass substrate 1.

Specific examples of such a material include glasses such as quartz, aluminosilicate glass, borosilicate glass, phosphate glass, fluorophosphate glass; “AF33”, “AF32”, “BOROFLOAT 33”, “D263T”, “D263Teco”, “D263LA” and “B270”, manufactured by Schott; “SW-3”, “SW-Y”, “SW-YY”, “AN100”, “EN-A1”, “PYREX”, “FP1”, “FP10”, “FP01eco”, “FL”, “JFL” and “NF50”, manufactured by Asahi Glass Co., Ltd.; “Eagle 2000” and “Eagle XG”, manufactured by Corning Incorporated; and “ABC” and “BDA”, manufactured by Nippon Electric Glass Co., Ltd. (the above products include the cases of trade names and registered trademarks). Particularly, glasses such as “D263T”, “D263Teco”, “D263LA” and “B270”, manufactured by Schott; “BDA” manufactured by Nippon Electric Glass Co., Ltd.; and “FP1”, “FP10”, “FP01eco”, “FL” and “JFL”, manufactured by Asahi Glass Co. Ltd. have a coefficient of linear expansion close to that of ceramics such as alumina and are more preferred as the material of the glass substrate 1.

For reference, an imaging element of a silicon substrate is more commonly used in an optical device using light of visible wavelength band, and silicon as a material thereof has a coefficient of linear expansion of about 3×10⁻⁶/K. Furthermore, an imaging element of a germanium substrate is more commonly used in an optical device using light of infrared wavelength band, and germanium as a material thereof has a coefficient of linear expansion of about 6×10⁻⁶/K. Alumina ceramics is sometimes used as a material of an outer frame when packaging an imaging element. The alumina ceramics has a coefficient of linear expansion of about 6×10⁻⁶ to 8×10⁻⁶/K.

When the glass material is “AN100”, a coefficient of linear expansion thereof is about 38×10⁻⁷/K. When the glass material is “SW”, a coefficient of linear expansion thereof is about 33×10⁻⁷/K. When the glass material is “AF33”, a coefficient of linear expansion thereof is about 33×10⁻⁷/K. When the glass material is “PYREX”, a coefficient of linear expansion thereof is about 33×10⁻⁷/K. When the glass material is “AF32”, a coefficient of linear expansion thereof is about 32×10⁻⁷/K. When the glass material is “BOROFLOAT 33”, a coefficient of linear expansion thereof is about 33×10⁻⁷/K. When the glass material is “Eagle 2000”, a coefficient of linear expansion thereof is about 32×10⁻⁷/K. When the glass material is “ABC”, a coefficient of linear expansion thereof is about 38×10⁻⁷/K. When the glass material is “FP-1”, a coefficient of linear expansion thereof is about 52×10⁻⁷/K. When the glass material is “BDA”, a coefficient of linear expansion thereof is about 66×10⁻⁷/K. When the glass material is “D263”, a coefficient of linear expansion thereof is about 72×10⁻⁷/K. When the glass material is fluorosilicate glass, a coefficient of linear expansion thereof is 120×10⁻⁷/K to 150×10⁻⁷/K. When the glass material is phosphate glass, a coefficient of linear expansion thereof is 70×10⁻⁷/K to 120×10⁻⁷/K.

The material of the glass substrate 1 having smaller amount of an α-ray emission can suppress noise generation in an imaging element due to α-ray and damage of an imaging element, and is therefore preferred. The amount of an α-ray emission from the material of the glass substrate 1 is preferably 0.01 c/cm²·hr or less, and more preferably 0.005 c/cm²·hr or less.

A production method of the microlens array 10 according to the present embodiment is described below. FIG. 2 is an explanatory view showing one example of a production method of the microlens array 10 according to the present embodiment. In FIG. 2, among a plurality of microlenses 11 formed on the glass substrate 1, attention is paid to one microlens 11, and steps of forming the microlens 11 on the glass substrate are shown. However, in the actual production step, a plurality of microlenses 11 is simultaneously formed, and as a result, the microlens array structure 12 is formed.

In the example shown in FIG. 2, a resist 201 is first applied to a surface of the glass substrate 1 on which the microlens array structure 12 is to be formed (FIG. 2(a): resist application step). The resist 201 may be, for example, an acrylic positive type resist. The resist 201 is exposed using a mask 202 used at a position corresponding to a position on the glass substrate 1 at which an individual microlens 11 is desired to be formed, and then developed, thereby forming a state that the resist 201 having a rectangular cross-sectional shape remains at the position of the glass substrate 1 on which the microlens 12 is desired to be formed (FIG. 2(b): exposure step, FIG. 2(c): development step).

Next, the resist 201 remained in the development step of FIG. 2(c) is formed in a spherical surface shape by thermal reflow (FIG. 2(d): thermal reflow step). When the spherical surface-shaped resist 201 is formed on the glass substrate 1, dry etching of the glass substrate 1 is conducted utilizing the resist 201 as a mask, and a microlens 11 is formed (FIG. 2(e): dry etching step, FIG. 2(f): completion drawing).

It is possible to conduct a step of imparting a spherical surface shape to the resist 201 by conducting photolithography using a gray scale mask in place of the steps of from the exposure step of FIG. 2(b) to the thermal reflow step of FIG. 2(d).

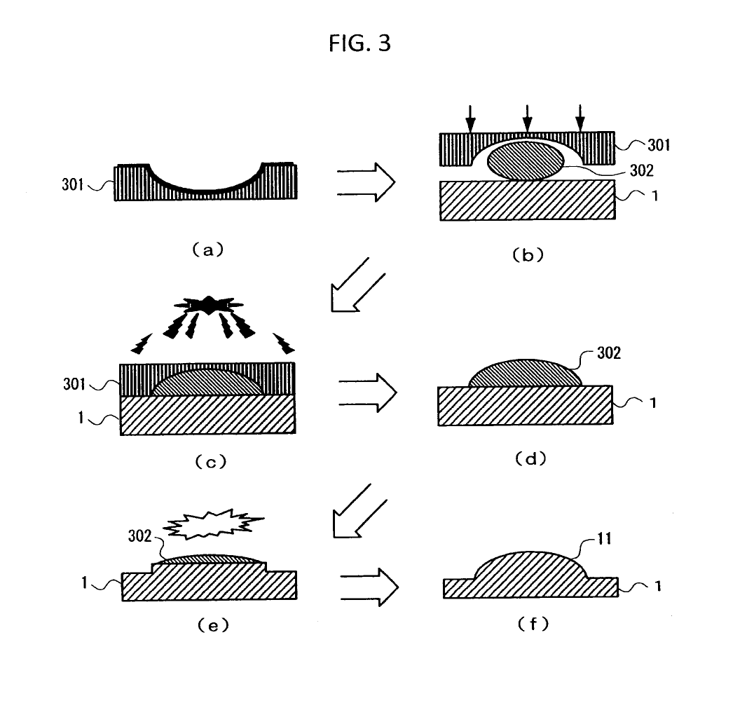

FIG. 3 is an explanatory view showing another example of a production method of the microlens array 10 according to the present embodiment. In FIG. 3, attentions is paid to one microlens 11 among a plurality of microlenses 11 formed on the glass substrate 1, and FIG. 3 shows steps of forming the microlens 11 on the glass substrate. However, in the actual production step, a plurality of microlenses 11 is simultaneously formed, and as a result, the microlens array structure 12 is formed.

In the example shown in FIG. 3, a mold 301 corresponding to a shape of the desired microlens array structure 12 to be formed is prepared, and in order to increase releasability from a molding material to be transferred, a polymer type SAM (self-assembled monomer) film or DLC (diamond-like carbon) film is applied to the mold 301 (FIG. 3(a): release treatment step). An imprint material 302 is selectively applied to a position on the glass substrate 1 where a microlens is desired to be formed. Thereafter, the mold having been subjected to a release treatment in FIG. 3(a) is pressed to the imprint material 302 to extend and expand the imprint material 302, thereby forming into a shape of the mold 301, that is, a spherical surface-shaped structure arranging in an array shape (FIG. 3(b): photosensitive monomer formation step). For example, a photosensitive acrylic monomer may be used as the imprint material 302.

The imprint material 302 formed through the mold 301 is irradiated with light to photocure the imprint material 302, and a spherical surface-shaped structure formed of the cured imprint material 302 is formed (FIG. 3(c): exposure step). Thereafter, the mold 301 is released (FIG. 3(d): mold release step).

After the spherical surface-shaped structure formed of the cured imprint material 302 has been formed on the glass substrate 1, dry etching of the glass substrate 1 is conducted utilizing its pattern as a mask, thereby forming the microlens 11 (FIG. 3(e): dry etching step, FIG. 3(f): completion drawing).

It is possible to conduct a step of applying a thermoplastic resin film as the imprint material 302 and then heating and pressurizing through the mold 301 to perform forming, in place of the steps of from the photosensitive monomer formation step of FIG. 3(b) to the exposure step of FIG. 3(c).

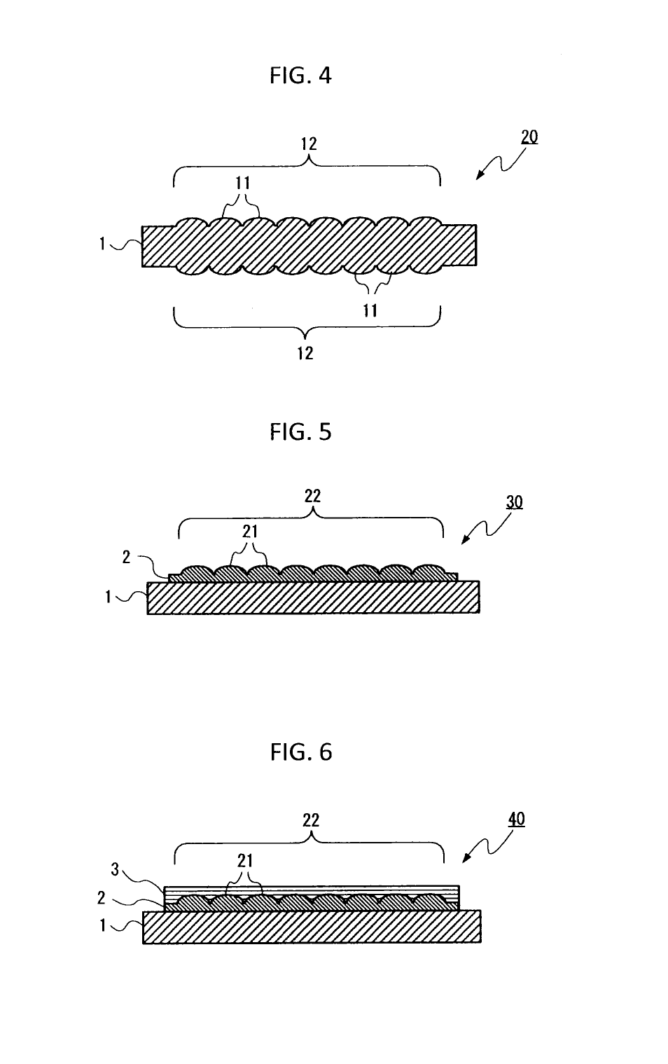

The example of forming the microlens array structure 12 on one surface of the glass substrate 1 is shown in FIG. 1, but it is possible to form the microlens array structure 12 on both surfaces of the glass substrate 1 as in, for example, a microlens 20 shown in FIG. 4. FIG. 4 is a configuration diagram showing another example of a microlens array in the present invention.

In a production method of the microlens array 20 shown in FIG. 4, the same steps as in the production step of the microlens array 10 shown in FIG. 1 may be applied to both surfaces of the glass substrate 1.

FIG. 5 is a configuration diagram showing another example of the microlens array in the present invention. A microlens array 30 shown in FIG. 5 is formed by providing a microlens array structure 22 formed of a resin layer 2 on one light-transmitting surface of the glass substrate 1. More specifically, the microlens array 30 is formed by stacking the resin layer 2 which has been formed into the microlens array structure 22 composed of microlenses 21 arranged in an array shape, on one light-transmitting surface of the glass substrate 1.

The resin layer 2 may be formed by, for example, utilizing the resist 201 used in the production steps shown in FIG. 2. In this case, the resist 201 having been formed in a spherical surface shape, which is formed in the production step shown in FIG. 2, is directly used as the microlens 11.

Furthermore, the resin layer 2 can be formed by utilizing, for example, the imprint material 302 used in the production step shown in FIG. 3. In this case, the imprint material 302 having been formed in a spherical surface shape, which is formed in the production step shown in FIG. 3, is directly used as the microlens array 11.

Examples of the resin materials in the present example include acrylic positive type resist materials such as “TMR-P15” manufactured by Tokyo Ohka Kogyo Co., Ltd. Further examples thereof include imprint materials of photosensitive acrylic monomer, such as “NIF-A-7g” and “NIF-A-1”, manufactured by Asahi Glass Co., Ltd.

In the present example, the material of the glass substrate 1 constituting the microlens array substrate is a material having a coefficient of linear expansion close to that of a material of the bonded part of the imaging element to which the glass substrate 1 is to be bonded. The material of the resin layer 2 preferably has a coefficient of linear expansion close to that of a material of the bonded part of the imaging element to which the glass substrate 1 is to be bonded, but this is not essential. That is, because the resin layer 2 is adhered to the glass substrate 1, position shift can be suppressed by adhesiveness of the resin that is a material of the resin layer 2.

The production method of the microlens array 30 in the present example excludes the dry etching step in the production method of the microlens array 10 shown in FIG. 1.

FIG. 6 is a configuration diagram showing another example of a microlens array in the present invention. In a microlens array 40 shown in FIG. 6, a cover layer 3 is further provided on the resin layer 2 of the microlens array 30 shown in FIG. 5. A target on which the cover layer 3 is provided is not limited to a microlens array formed by the resin layer, and the cover layer can be provided on, for example, a microlens array made of a glass as in the microlens array 10 shown in FIG. 1. In this case, the cover layer 3 has only to be formed in a range covering the region where at least a microlens is formed.

The cover layer 3 may be formed using, for example, a resin. The microlens array structures 12 and 22 can be protected by providing the cover layer 3. Furthermore, by providing the cover layer 3, the control range of a focal length can be widened as compared with the case of only a lens layer. There is a usage that the cover layer 3 is provided in the case where a curvature radius cannot be increased but a focal length is desired to be increased.

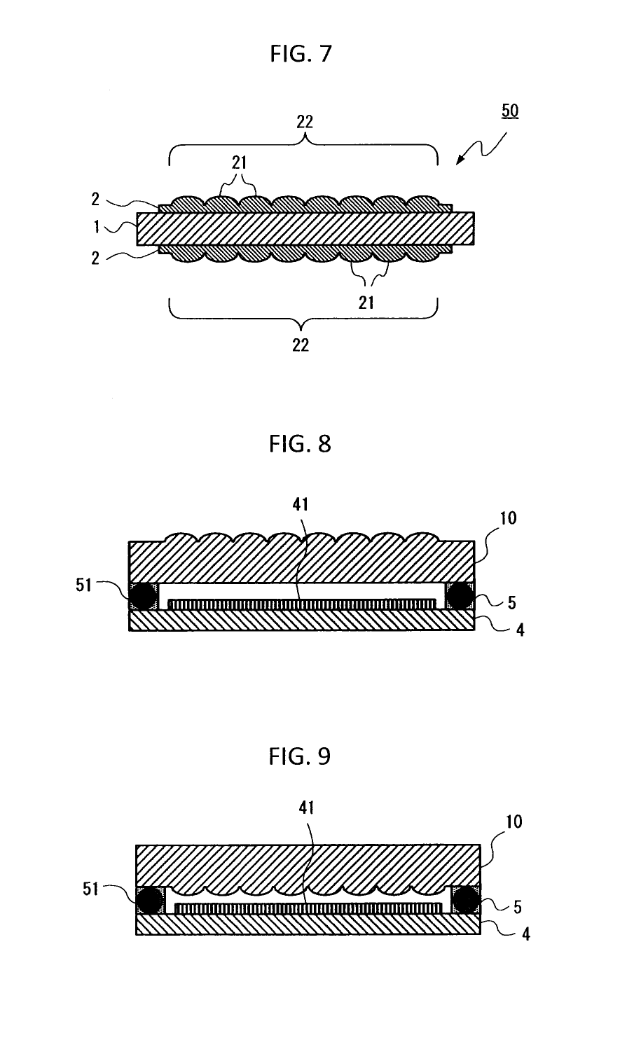

The example of the microlens array in which the resin layer 2 having the microlens array structure 22 formed therein is adhered on one surface of the glass substrate 1 is shown in FIGS. 5 and 6. However, it is possible to provide the resin layer 2 having the microlens array 22 formed therein on both surfaces of the glass substrate 1 as same as in the example shown in FIG. 4. FIG. 7 is a configuration diagram showing an example of a microlens array in the case where the microlens array structure 22 made of a resin has been provided on both surfaces. Although not shown, it is possible to further provide the cover layer 3 on the respective microlens array structures 12 and 22.

Next, the example of bonding a microlens array to an imaging element substrate or imaging element package is described. FIGS. 8 to 12 are explanatory views showing an example of bonding a microlens array to an imaging element substrate or imaging element package according to the present invention.

For example, as shown in FIG. 8, an imaging element substrate 4 having formed thereon a light-receiving element array 41 corresponding to a given pixel pitch and the microlens array substrate 1 may be directly bonded to each other using an adhesive 5 containing a gap spacer 51.

A target to which the microlens array substrate is bonded in this method is the imaging element substrate 4. Therefore, when the imaging element substrate 4 is a silicon substrate, a glass having a coefficient of linear expansion close to a coefficient of linear expansion of silicon may be used as a material of the glass substrate 1 constituting the microlens array substrate. Furthermore, when the imaging element substrate 4 is a germanium substrate, a glass having a coefficient of linear expansion close to a coefficient of linear expansion of germanium may be used as a material of the glass substrate 1 constituting the microlens array substrate.

As the adhesive 5, for example, an epoxy type thermosetting or photo-curable resin is used. Other than this, an acrylic or silicon type thermosetting or photo-curable resin may be used.

FIG. 8 shows an example of bonding such that a lens face is front (incident side), but as shown in FIG. 9, it is possible to bond to the imaging element substrate 4 such that a lens face is back. It is preferred that the microlens array structure 12 is provided on both surfaces from the standpoint that aberration can be suppressed.

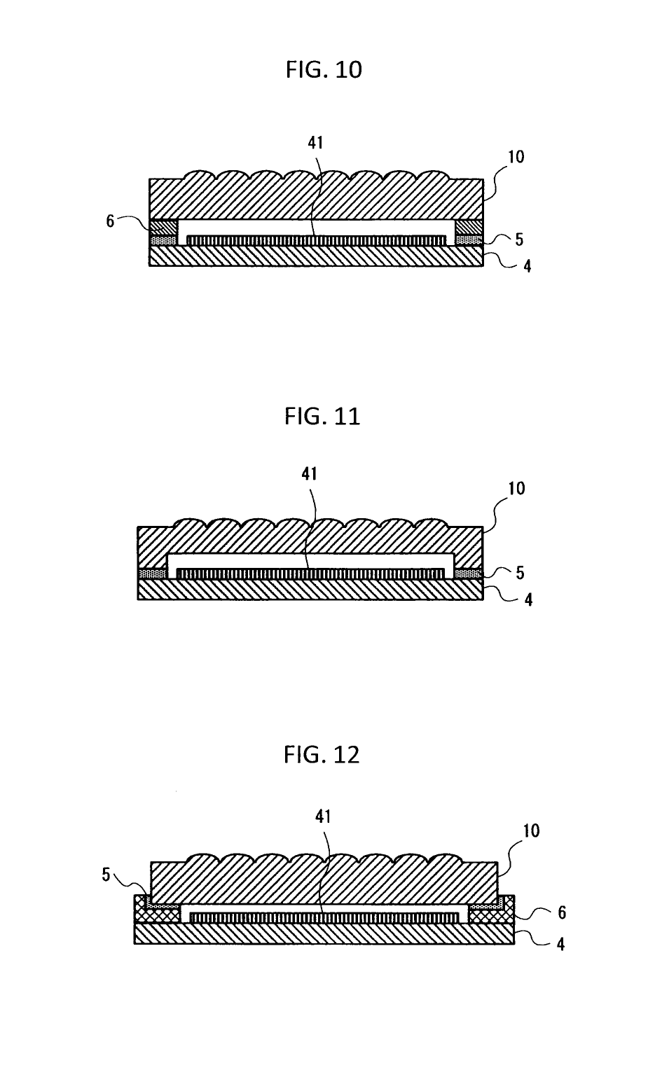

The example shown in FIG. 10 is an example that a desired height is formed using a resist 6 having been subjected to photolithography in place of the gas spacer 51, and the microlens array substrate is bonded to the imaging element substrate 4 through the resist 6 with the adhesive 5.

A target to which the microlens array substrate is bonded in this method can be considered to be substantially the imaging element substrate 4, excluding a resin material such as a resin type resist or resin type adhesive. Therefore, when the imaging element substrate 4 is a silicon substrate, a glass having a coefficient of linear expansion close to a coefficient of linear expansion of silicon may be used as a material of the glass substrate 1 constituting the microlens array substrate. Furthermore, when the imaging element substrate 4 is a germanium substrate, a glass having a coefficient of linear expansion close to a coefficient of linear expansion of germanium may be used as a material of the glass substrate 1 constituting the microlens array substrate.

Furthermore, as shown in FIG. 11, the microlens array substrate 1 can be bonded to the imaging element substrate 4 with the adhesive 5 by digging down the surface of the microlens array substrate 1 while remaining an outer edge of the surface of the side on which the microlens array structure 12 is not provided, and using the height of the outer edge remained, in place of a spacer.

A target to which the microlens array substrate is bonded in this method is the imaging element substrate 4. Therefore, when the imaging element substrate 4 is a silicon substrate, a glass having a coefficient of linear expansion close to a coefficient of linear expansion of silicon may be used as a material of the glass substrate 1 constituting the microlens array substrate. Furthermore, when the imaging element substrate 4 is a germanium substrate, a glass having a coefficient of linear expansion close to a coefficient of linear expansion of germanium may be used as a material of the glass substrate 1 constituting the microlens array substrate.

According to the bonding method shown in FIGS. 8 to 11, after bonding a wafer constituting a plurality of the imaging element substrates 4 (for example, silicon wafer or germanium wafer) to a glass wafer constituting a plurality of the microlens array substrates 1, the resulting assembly can be cut to form individual pieces.

In the case of the constitution that the imaging element substrate 4 is housed in a package made of ceramics as shown in FIG. 12, the microlens array substrate 1 is adhered to its package opening by an adhesive to form one optical component.

A target to which the microlens array substrate is bonded in this method is a ceramics package 6. Therefore, a glass having a coefficient of linear expansion close to a coefficient of linear expansion of ceramics that is a material of the ceramics package 6 may be used as a material of the glass substrate 1 constituting the microlens array substrate.

Although not shown in the drawings, in the case where the purpose of combining the microlens array with a pixel array of the imaging element is the use application in a light field camera, a position and size of each microlens and each imaging element, and a focal length of the microlens may be determined such that light passing through one microlens disperses and enters a plurality of imaging elements

As described above, according to the present embodiment, in an optical device using a combination of a microlens array and a pixel array of an imaging element, a shift of light-concentrating spot due to position shift between the microlens array and the pixel array of the imaging element during temperature rising due to the difference in coefficient of linear expansion between the microlens array substrate and the imaging element substrate or imaging element package to which the microlens array substrate is to be bonded can be prevented.

Furthermore, when a glass having small amount of an α-ray emission is used as a material of the microlens array substrate, occurrence of noises due to α-ray in an imaging element and damage of an imaging element can be prevented.

### Example 1

The microlens array according to the present invention and an imaging element package including the microlens array as an integrated package are described below by reference to specific examples. In the first example, “SW-YY” glass manufactured by Asahi Glass Co., Ltd. is used in the microlens array substrate 1. In the microlens array in this example, a positive type photoresist material is spin-coated on one surface of the glass substrate 1 produced using “SW-YY” glass (hereinafter referred to as SW glass) at a rate of 1,300 rpm, followed by heating to 100° C. to form a resist film having a thickness of 1.7 μm. THMR-iP3100 (manufactured by Tokyo Ohka Kogyo Co., Ltd.) is used as the resist material.

Then, the resist film obtained is exposed through a photomask. Thereafter, the photoresist of a sensitized portion is removed by a developer to prepare SW glass having formed thereon a resist pattern in which circular cylinders each having a diameter of 31 μm and a height of 1.7 μm are arranged in a pitch of 32 μm.

Then, the resist pattern of the circular cylinder obtained is heated to 200° C. to melt the resist, thereby forming a convex spherical surface-shaped resist having a curvature radius of 44.4 μm.

The resist and SW glass are etched by a reactive ion etching method using a mixed gas containing CF₄ (methane tetrafluoride) gas and BCl₃ (boron trichloride) gas to transfer a lens shape to the SW glass, thereby preparing the microlens array 10 having the microlens array structure 12 in which microlenses 11 each having a curvature radius of 62.4 μm are arranged in a pitch of 32 μm. In the case of preparing a plurality of the microlens arrays 10 at one time using a glass wafer, the glass wafer may be cut here by dicing to form the individual microlens array 10. In this case, the bonding to an imaging element is carried out using the individual piece.

In the microlens array 10 thus prepared and a semiconductor substrate having an imaging element formed thereon, to control a distance between the lens and the imaging element, an adhesive containing a 120 μm spacer is applied so as to surround a light receiving region and then photocured. As the adhesive, an epoxy adhesive is used.

In the case of this example, a coefficient of linear expansion of the SW-YY glass substrate is 33×10⁻⁷ (/K), and a coefficient of linear expansion of the semiconductor substrate to which the SW-YY glass substrate is to be bonded is 33×10⁻⁷ (/K). Thus, the difference in coefficient of linear expansion between them is 1×10⁻⁷ (/K) or less. Therefore, position shift of a pixel pitch of the imaging element and lens pitch due to a working temperature and generation of heat from the difference in coefficient of linear expansion can be prevented. Furthermore, when conducting reflow mounting to a print wiring substrate, peeling between substrates can be prevented.

The amount of an α-ray emission from the SW glass substrate is 0.01 c/cm²-hr or less. From this fact, generation of noise due to an α-ray in the imaging element can be prevented

### Example 2

In the second example, “AN 100” glass manufactured by Asahi Glass Co., Ltd. is used in the microlens array substrate 1. In the microlens array in this example, a positive type photoresist material is spin-coated on one surface of the glass substrate 1 produced using “AN 100” glass (hereinafter referred to as AN glass) at a rate of 2,500 rpm, followed by heating to 100° C. to form a resist film having a thickness of 1.3 μm. THMR-iP3100 (manufactured by Tokyo Ohka Kogyo Co., Ltd.) is used as the resist material.

Then, the resist film obtained is exposed through a photomask. Thereafter, the photoresist of a sensitized portion is removed by a developer to prepare AN glass having formed thereon a resist pattern in which circular cylinders each having a diameter of 31 μm and a height of 1.3 μm are arranged in a pitch of 32 μm.

Then, the resist pattern of the circular cylinder obtained is heated to 200° C. to melt the resist, thereby forming a convex spherical surface-shaped resist having a curvature radius of 56.4 μm.

The resist and AN glass are etched by a reactive ion etching method using a mixed gas containing CF₄ (methane tetrafluoride) gas and BCl₃ (boron trichloride) gas to transfer a lens shape to the AN glass, thereby preparing the microlens array having the microlens array structure 12 in which microlenses 11 each having a curvature radius of 62.4 μm are arranged in a pitch of 32 μm. In this example, the glass wafer is cut here by dicing to form the individual microlens array.

The microlens array thus prepared is bonded to a semiconductor substrate having an imaging element formed thereon, thereby preparing an imaging element package for a light field camera. The method for bonding the microlens array to the semiconductor substrate and the semiconductor substrate to which the microlens array is to be bonded are the same as in the first example.

In the case of this example, a coefficient of linear expansion of the AN glass substrate is 38×10⁻⁷ (/K), and a coefficient of linear expansion of the semiconductor substrate to which the AN glass substrate is to be bonded is 33×10⁻⁷ (/K). Thus, the difference in coefficient of linear expansion between them is 1×10⁻⁶ (/K) or less. Therefore, position shift of a pixel pitch of the imaging element and lens pitch due to a working temperature and generation of heat from the difference in coefficient of linear expansion can be prevented. Furthermore, when conducting reflow mounting to a print wiring substrate, peeling between substrates can be prevented.

### Example 3

In the third example, quartz glass is used in the microlens array substrate 1. In the microlens array of this example, a positive type photoresist material is spin-coated on one surface of the quartz glass substrate at a rate of 2,900 rpm, followed by heating to 100° C. to form a resist film having a thickness of 1.2 μm. THMR-iP3100 (manufactured by Tokyo Ohka Kogyo Co., Ltd.) is used as the resist material.

Then, the resist film obtained is exposed through a photomask. Thereafter, the photoresist of a sensitized portion is removed by a developer to prepare quartz glass having formed thereon a resist pattern in which circular cylinders each having a diameter of 31 μm and a height of 1.2 μm are arranged in a pitch of 32 μm.

Then, the resist pattern of the circular cylinder obtained is heated to 200° C. to melt the resist, thereby forming a convex spherical surface-shaped resist having a curvature radius of 60.5 μm.

The resist and quartz glass are etched by a reactive ion etching method using a mixed gas containing CF₄ (methane tetrafluoride) gas and CHF₃ gas to transfer a lens shape to the quartz glass, thereby preparing the microlens array having the microlens array structure in which microlenses each having a curvature radius of 55.2 μm are arranged in a pitch of 32 μm. In this example, the glass wafer is cut here by dicing to form the individual microlens array.

The microlens array thus prepared is bonded to a semiconductor substrate having an imaging element formed thereon, thereby preparing an imaging element package for a light field camera. The method for bonding the microlens array to the semiconductor substrate and the material of the semiconductor substrate are the same as in the first example.

In the case of this example, a coefficient of linear expansion of the quartz glass substrate is 6×10⁻⁷ (/K), and a coefficient of linear expansion of the semiconductor substrate to which the quartz glass substrate is to be bonded is 33×10⁻⁷ (/K). Thus, the difference in coefficient of thermal expansion between them is 3×10⁻⁶ (/K) or less. Therefore, position shift of a pixel pitch of the imaging element and lens pitch due to a working temperature and generation of heat from the difference in coefficient of linear expansion can be prevented. Furthermore, when conducting reflow mounting to a print wiring substrate, peeling between substrates can be prevented.

### Comparative Example 1

Microlens array prepared using a resin substrate and an imaging element package including the microlens array as an integrated package are described below as a comparative example.

In the microlens array of this comparative example, as a preparatory stage, a positive type photoresist material is spin-coated on one surface of the quartz glass substrate at a rate of 2,900 rpm, followed by heating to 100° C. to form a resist film having a thickness of 1.2 μm. THMR-iP3100 (manufactured by Tokyo Ohka Kogyo Co., Ltd.) is used as the resist material.

The resist film obtained is exposed through a photomask. Thereafter, the photoresist of a sensitized portion is removed by a developer to prepare quartz glass having formed thereon a resist pattern in which circular cylinders each having a diameter of 31 μm and a height of 1.2 μm are arranged in a pitch of 32 μm.

Then, the resist pattern of the circular cylinder obtained is heated to 200° C. to melt the resist, thereby forming a convex spherical surface-shaped resist having a curvature radius of 60.5 μm.

Then, Ni film is formed on the glass substrate surface having the convex spherical surface-shaped resist formed thereon, by a sputtering method, and 1 mm thick Ni plating is applied thereon by electroplating method. Ni is peeled from a matrix to prepare a convex spherical surface-shaped Ni mold. Thus, the preparatory stage is completed.

After the mold is prepared, a release agent is spin-coated on the Ni mold prepared, followed by burning at 100° C., and a fluorine treatment is conducted.

An acrylic photocurable resin is dropped between the fluorine-treated Ni mold and a polycarbonate substrate that is the microlens array substrate in this example, and the mold and the polycarbonate substrate are superposed. The resin is filled between the mold and the polycarbonate substrate while equally pressuring the entire surface.

Parallelism matching and positioning between the mold and the polycarbonate substrate are conducted in the state that the resin is filled between the mold and the polycarbonate substrate, and UV exposure is conducted through the polycarbonate substrate. After the UV exposure, burning is conducted at 85° C. to sufficiently cure the resin. The mold is released from the substrate to prepare a microlens array in which the microlens array substrate is the resin substrate, having a microlens array structure in which microlenses each having a curvature radius of 60.2 μm are arranged in a pitch of 32 μm.

The microlens array thus prepared is bonded to a semiconductor substrate having an imaging element formed thereon to prepare an imaging element package for a light field camera. The method for bonding the microlens array to the semiconductor substrate and the semiconductor substrate to which the microlens is to be bonded are the same as in the first example.

In the case of this example, a coefficient of linear expansion of the polycarbonate substrate is 690×10⁻⁷ (/K), and a coefficient of linear expansion of the semiconductor substrate to which the polycarbonate substrate is to be bonded is 33×10⁻⁷ (/K). Thus, the difference in coefficient of linear expansion between them is 657×10⁻⁷ (/K) and is large. For this reason, there is a concern that peeling of substrates to each other occurs when conducting reflow mounting to a print wiring substrate. Furthermore, there is a concern that position shift of a pixel pitch of the imaging element and lens pitch due to a working temperature and generation of heat from the difference in coefficient of linear expansion occurs. When the imaging element package in this example is operated in an environment of a temperature of 65° C. by the experiment, position shift is confirmed.

Although the present invention has been described in detail and by reference to the specific embodiments, it is apparent to one skilled in the art that various modifications or changes can be made without departing from the spirit and scope of the present invention.

This application is based on Japanese Patent Application No. 2012-050641 filed on Mar. 7, 2012, the disclosure of which is incorporated herein by reference in its entity.

### INDUSTRIAL APPLICABILITY

The technique of the present invention can be preferably used in not only the application of a light field camera, but also an optical device using a microlens array and a pixel array of an imaging element in combination, so long as it has high precision in positioning of the microlens array and pixel array of an imaging element.

### DESCRIPTION OF REFERENCE NUMERALS AND SIGNS

10, 20, 30, 40, 50 Microlens array
1 Microlens array substrate
11 Microlens (made of glass)
12 Microlens array structure (made of glass)
2 Resin layer
21 Microlens array (made of resin)
22 Microlens array structure (made of resin)
3 Cover layer
4 Imaging element substrate
41 Light receiving element array (pixel array)
5 Adhesive
6 Package
201 Resist
202 Mask
301 Mold
302 Imprint material

1. A microlens array to be used in combination with a pixel array of an imaging element, comprising:
a glass substrate; and
a plurality of microlenses provided on at least one surface of the glass substrate and arranged in an array shape,
wherein each of the plurality of the microlenses is constituted such that light to be entered into the microlens is received by a plurality of pixels of the imaging element, and
a difference between a coefficient of linear expansion of the glass substrate and a coefficient of linear expansion of an imaging element substrate having the pixel array formed thereon or member of a package to be bonded to the imaging element substrate is within 8×10⁻⁶ (/K).

2. The microlens array according to claim 1, wherein an amount of an α-ray emission from the glass substrate is 0.01 c/cm²·hr or less.

3. The microlens array according to claim 1, further comprising:
a resin layer stacked on the glass substrate,
wherein the plurality of the microlenses is formed in the resin layer.

4. The microlens array according to claim 2, further comprising:
a resin layer stacked on the glass substrate,
wherein the plurality of the microlenses is formed in the resin layer.

5. The microlens array according to claim 1, further comprising:
a cover layer covering a region on which at least the microlens is formed.

6. The microlens array according to claim 2, further comprising:
a cover layer covering a region on which at least the microlens is formed.

7. The microlens array according to claim 3, further comprising:
a cover layer covering a region on which at least the microlens is formed.

8. The microlens array according to claim 4, further comprising:
a cover layer covering a region on which at least the microlens is formed.

9. The microlens array according to claim 1, which is to be bonded to a silicon substrate as the imaging element substrate,
wherein a coefficient of linear expansion of the glass substrate is within a range of from 0.3×10⁻⁶ (/K) to 11×10⁻⁶ (/K).

10. The microlens array according to claim 2, which is to be bonded to a silicon substrate as the imaging element substrate,
wherein a coefficient of linear expansion of the glass substrate is within a range of from 0.3×10⁻⁶ (/K) to 11×10⁻⁶ (/K).

11. The microlens array according to claim 3, which is to be bonded to a silicon substrate as the imaging element substrate,
wherein a coefficient of linear expansion of the glass substrate is within a range of from 0.3×10⁻⁶ (/K) to 11×10⁻⁶ (/K).

12. The microlens array according to claim 4, which is to be bonded to a silicon substrate as the imaging element substrate,
wherein a coefficient of linear expansion of the glass substrate is within a range of from 0.3×10⁻⁶ (/K) to 11×10⁻⁶ (/K).

13. The microlens array according to claim 1, which is to be bonded to a germanium substrate as the imaging element substrate,
wherein a coefficient of linear expansion of the glass substrate is within a range of from 0.3×10⁻⁶ (/K) to 14×10⁻⁶ (/K).

14. The microlens array according to claim 2, which is to be bonded to a germanium substrate as the imaging element substrate,
wherein a coefficient of linear expansion of the glass substrate is within a range of from 0.3×10⁻⁶ (/K) to 14×10⁻⁶ (/K).

15. The microlens array according to claim 3, which is to be bonded to a germanium substrate as the imaging element substrate,
wherein a coefficient of linear expansion of the glass substrate is within a range of from 0.3×10⁻⁶ (/K) to 14×10⁻⁶ (/K).

16. The microlens array according to claim 4, which is to be bonded to a germanium substrate as the imaging element substrate,
wherein a coefficient of linear expansion of the glass substrate is within a range of from 0.3×10⁻⁶ (/K) to 14×10⁻⁶ (/K).

17. The microlens array according to claim 1, which is to be bonded to a ceramics package as the package of the imaging element substrate,
wherein a coefficient of linear expansion of the glass substrate is within a range of from 0.3×10⁻⁶ (/K) to 15×10⁻⁶ (/K).

18. The microlens array according to claim 2, which is to be bonded to a ceramics package as the package of the imaging element substrate,
wherein a coefficient of linear expansion of the glass substrate is within a range of from 0.3×10⁻⁶ (/K) to 15×10⁻⁶ (/K).

19. The microlens array according to claim 3, which is to be bonded to a ceramics package as the package of the imaging element substrate,
wherein a coefficient of linear expansion of the glass substrate is within a range of from 0.3×10⁻⁶ (/K) to 15×10⁻⁶ (/K).

20. An imaging element package comprising:
an imaging element substrate on which a light receiving element is formed corresponding to a given pixel pitch; and
a microlens array in which a plurality of microlenses are arranged in an array shape on at least one surface of a glass substrate,
wherein each of the plurality of the microlenses constituting the microlens array makes the light receiving element corresponding to a plurality of pixels on the imaging element substrate receive light to be entered into the microlens,
a difference between a coefficient of linear expansion of the glass substrate of the microlens array and a coefficient of linear expansion of the imaging element substrate or member of a package to be bonded to the imaging element substrate is within 8×10⁻⁶ (/K), and
the glass substrate of the microlens array is bonded to the imaging element substrate or package to which the imaging element substrate is bonded, through a resin material.
